(19) United States
(12) Patent Application Publication
(10) Pub. No.: US 2012/0266445 A1
(43) Pub. Date: Oct. 25, 2012

(54) INSERTED METAL REMOVAL SYSTEM USING HIGH FREQUENCY WAVE

(75) Inventor: Jae Soo Gwon, Yongin (KR)

(73) Assignee: HYUNDAI MOTOR COMPANY, Seoul (KR)

(21) Appl. No.: 13/221,089

(22) Filed: Aug. 30, 2011

(30) Foreign Application Priority Data
Apr. 20, 2011 (KR) 10-2011-0036966

(51) Int. Cl. B23P 11/02; B23P 19/00

(52) U.S. Cl. 29/446; 29/700

(57) ABSTRACT

Provided is an inserted metal removal system using a high frequency wave, in particular, a system for removing metal, inserted into a plastic part, using high frequency waves, thus improving the recyclability of the plastic part. For this purpose, the present invention provides an inserted metal removal system using a high frequency wave, the system including: a rotating table on which a plastic part with an inserted metal therein is placed and fixed and a matching box being moved up and down on the metal inserted into the plastic part by a balancer provided above the rotating table. The matching box generates and transmits high frequency waves to the metal part to melt the plastic surrounding the periphery thereof. A coil box including a heating coil mounted therein, inductively heats a heating unit provided at an end of the coil box by the high frequency waves transmitted from the matching box, and a cooler prevents the heating coil from overheating.

### CROSS-REFERENCE TO RELATED APPLICATION

This application claims under 35 U.S.C. §119(a) the benefit of Korean Patent Application No. 10-2011-0036966 filed Apr. 20, 2011, the entire contents of which are incorporated herein by reference.

### BACKGROUND

(a) Technical Field

The present invention relates to an inserted nut removal system using a high frequency wave. More particularly, it relates to a system for removing a metal insert, inserted into a plastic part, using a high frequency wave, thereby improving the recyclability of plastic parts by allowing the above parts and/or materials to be reused.

(b) Background Art

Recently, the regulations for the treatment of end-of-life vehicles, which have been legislated in Korea, Japan, and China as well as in the EU, require more than 85% recycling of various materials from the end-of-life vehicles with respect to the total weight and more than 95% heat recovery. However, for various reasons, such as weight reduction, fuel efficiency, etc., various parts made of ferrous and nonferrous metals have been replaced with engineering plastic parts in OEM vehicle production. Therefore, it is necessary to develop a technology for recycling the plastic parts replacing the metal parts, in addition to the existing recycling technologies.

Among various engine parts of the vehicle, which have been replaced with the plastic parts, expensive nylon plastic materials have been applied to cylinder head covers, intake manifolds, etc., as shown in FIG. 1. However, they are not recycled due to the presence of inserts (i.e., metal nuts and bushings for engine assembly), so instead they are entirely discarded.

Presently, in the case of inserted nut into plastic parts such as cylinder head covers and intake manifolds, attempts to recycle the plastic parts by removing the nuts by physical to destruction using air tools, hammers, etc., have been made. However, the engineered plastics used in the engine have a very high strength, and thus many times these attempts were not efficient or successful.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an inserted nut removal system using a high frequency wave, which can rapidly and conveniently separate and remove a metal insert from a plastic part by heating a nut inserted therein (hereinafter “the inserted nut”) by the heat transfer of a heating unit, which is inductively heated by high frequency waves, to melt the plastic part around the inserted nut.

More specifically, the present invention provides an inserted nut removal system using high frequency waves. In particular a plastic part with an inserted nut therein is placed and fixed on a rotating table. A matching box is moved up and down on the inserted nut of the plastic part by a balancer provided at the top of the rotating table and one or more high frequency waves are generated and transmitted to from the matching box. A coil box including a heating coil mounted therein to inductively heat a heating unit is provided at a to distal end of the coil box by the high frequency waves transmitted from the matching box. A cooler for preventing the heating coil from overheating is also provided. In turn, the inserted nut is heated by the heat transfer from the heating unit to melt the periphery of the inserted nut.

In a exemplary embodiment, the rotating table includes a fixed clamp and a movable clamp, which are configured to clamp the plastic part in such a manner that the movable clamp, which is configured to move linearly toward the fixed clamp, brings the plastic part into close contact with the fixed clamp to be fixed between the clamps.

In another exemplary embodiment, the rotating table is rotatably mounted.

In still another exemplary embodiment, the movable clamp comprises a movement guide bar provided at the bottom of the movable clamp and configured to guide the linear movement of the movable clamp. In particular, this movement guide bar is provided to move linearly along guide rails.

In yet another exemplary embodiment, the heating coil may have a pipe structure with a tube-like cross section such that coolant flows through the inside of the heating coil and the high frequency waves flow along the outer surface of the heating coil.

In still yet another exemplary embodiment, the rotating table is provided on a work cabinet, and the work cabinet comprises moving wheels mounted at the bottom of the work cabinet to ensure the movability of the system.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing vehicle engine parts made of plastic materials;

FIG. 2 is a diagram showing the configuration of an inserted nut removal system using a high frequency wave in accordance with an exemplary embodiment of the present invention;

FIG. 3 is a diagram showing a pair of clamps placed on a rotating table in an inserted nut removal system in accordance with an exemplary embodiment of the present invention;

FIG. 4 is a diagram showing the configuration for driving a rotating table and a clamp in an inserted nut removal system in accordance with an exemplary embodiment of the present invention;

FIG. 5 is a diagram showing the mounting structure of a matching box and a coil box in an inserted nut removal system in accordance with an exemplary embodiment of the present invention;

FIG. 6 is a diagram showing the cross-sectional structure of a heating coil in an inserted nut removal system in accordance with an exemplary embodiment of the present invention;

FIG. 7 is a diagram showing the flow of coolant and electric current in an inserted nut removal system in accordance with an exemplary embodiment of the present invention; and

FIG. 8 is a diagram showing an inserted nut in a plastic part heated by an inserted nut removal system in accordance with an exemplary embodiment of the present invention.

Reference numerals set forth in the Drawings includes reference to the following elements as further discussed below:

1: work cabinet

2: rotating table

3: support

4: fixed clamp

5: movable clamp

6: clamp moving motor

7: driving pulley

8: driving belt

9: driven pulley

10: movement converting unit

11: movement guide bar

12: guide rail

13: slide groove

14: table rotating motor

15: bevel gear

16: balancer

17: matching box

18: coil box

19: heating coil

22: heating unit

23: power supply

24: control box

25: moving wheel

26: vent pipe

27: cooler

It should be understood that the appended drawings are not necessarily to scale, to presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

The present invention provides an inserted nut removal system using high frequency waves, in which a metal nut inserted into a plastic part is separated and removed from the plastic part via temperature difference (or melting temperature difference) between the inserted nut and the plastic material, which are melted at different temperatures.

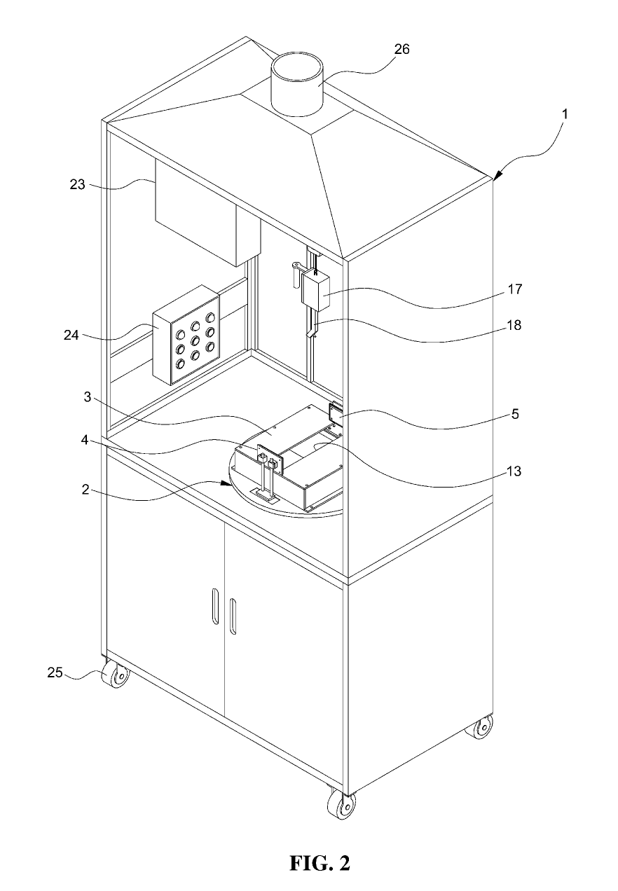

As shown in FIG. 2, an inserted nut removal system using a high frequency wave in accordance with an exemplary embodiment of the present invention is mounted on a movable work cabinet 1. A rotating table 2, on which a plastic part with a metal nut inserted therein is placed to perform a process of removing the insert nut from the plastic part, is provided on a worktable of the work cabinet 1.

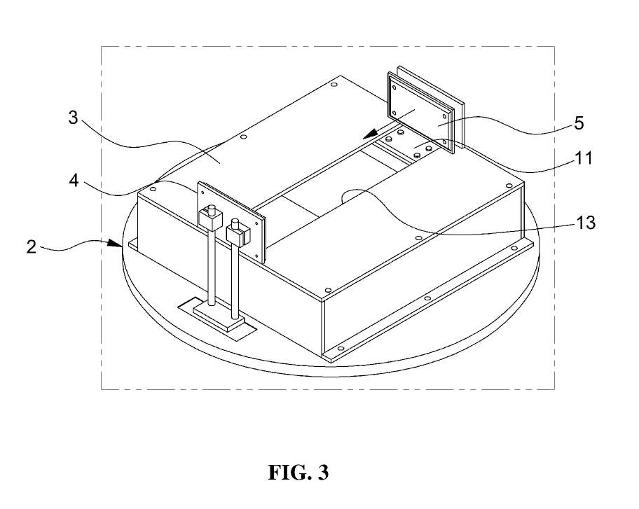

As shown in FIG. 3, the rotating table 2 includes a pair of clamps 4 and 5 for clamping the plastic part so that the plastic part is not lifted up when the inserted nut is removed from the plastic part. The clamps 4 and 5 illustratively include a fixed clamp 4 and a movable clamp 5 which face each other on a straight line. The fixed clamp 4 is fixedly provided at one edge of the rotating table 2, and the movable clamp 5 is configured to move linearly toward the fixed clamp 4.

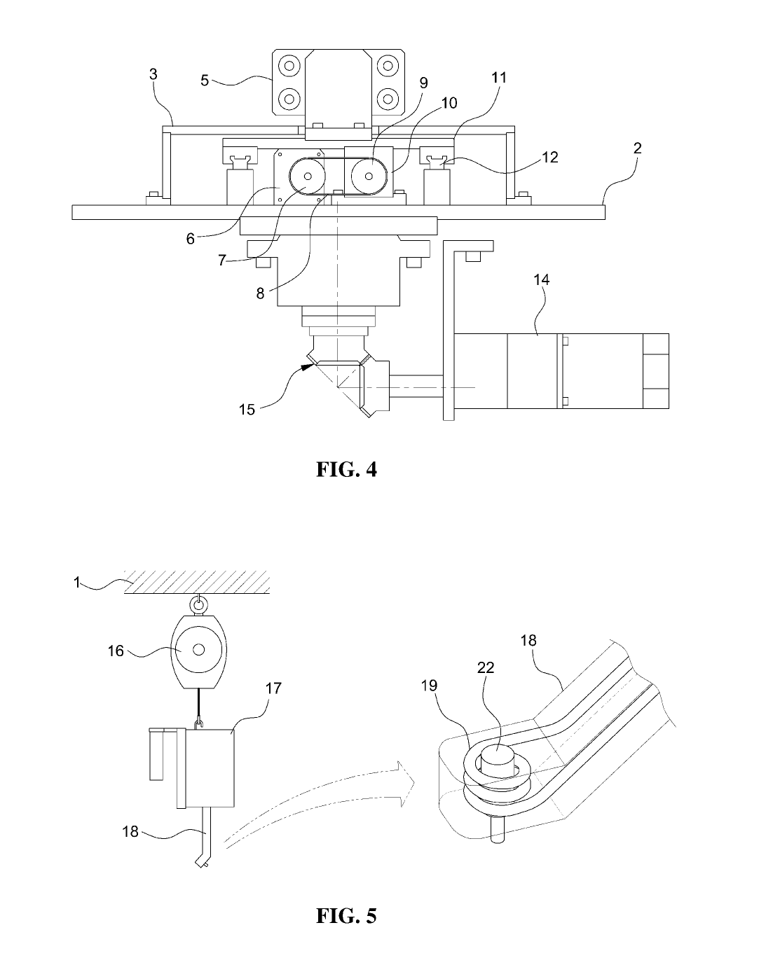

In detail, as shown in FIG. 4, the movable clamp 5 is moved by rotational force of a clamp moving motor 6 provided in a box-shaped support 3 on the rotating table 2. For this purpose, a driving pulley 7 is connected to a shaft of the clamp moving motor 6 to transmit the rotational force of the motor 6 to a driven pulley 9 through a driving belt 8. The driven pulley 9 transmits the rotational force of the motor 6 to the movable clamp 5 through a movement converting unit 10.

In some embodiments of the present invention, a screw-type pulley having a spiral outer surface maybe used as the driven pulley 9, however, the present invention should not be limited as such. Additionally, the movement converting unit 10 may have a spiral inner surface corresponding to the driven pulley 9, when a spiral screw-type pulley is utilized. That is, the movable clamp 5 illustratively is connected to the driving pulley 7, which transmits the rotational force of the clamp moving motor 6 to the driven pulley 9, and then to the movement converting unit 10, which converts the rotational movement of the driven pulley 9 into linear movement, thus performing linear movement. As such, the movable clamp 5 should move on the rotating table 2 within a small space, and thus the linear movement is implemented not by a cylinder device but by the clamp moving motor 6, the pulleys 7 and 9, and the movement converting unit 10 as a whole.

Moreover, a movement guide bar 11 for guiding the linear movement of the movable clamp 5 is mounted at the bottom of the movable clamp 5. More specifically, the movement to guide bar 11 is configured to move linearly along guide rails 12 fixed on the rotating table 2. The movement guide bar 11 connects between the movable clamp 5 and the movement converting unit 10 within the support 3. The movement guide bar 11 receives the rotational force of the clamp moving motor 6 through the movement converting unit 10 fixed at the bottom thereof and moves linearly together with the movable clamp 5. At this time, the movable clamp 5 moves along a slide groove 13 provided at the top of the support 3.

The rotating table 2 is rotatably mounted on the work cabinet 1 by a table rotating motor 14 received in the lower portion (bottom area) of the work cabinet 1 and a bevel gear 15 for transmitting the rotational force of the table rotating motor 14. Since a plurality of inserts (e.g., ten nuts and the like) are typically distributed in one plastic part, it is preferred that the rotating table 2 is rotatably mounted to improve working convenience during inserted nut removal.

Meanwhile, as shown in FIG. 5, a balancer 16 for up and down movement of a matching box 17 is provided on the top wall of the work cabinet 1. The balancer 16 is a pulley-type lift device that moves up and down the matching box 17 by winding or unwinding a wire. The matching box 17 is connected to the wire and is able to move in all directions within a certain range of the balancer 16.

When the matching box 17 is moved downward onto the plastic part placed on the to rotating table 2 by the balancer 16 provided on the top of the rotating table 2, a heated or heating unit 22 of a coil box 18 can be inserted into the inserted nut.

The matching box 17 may be a kind of high frequency generator, which is electrically connected to a power supply 23. When the power supply 23 supplies the electrical power required for generating high frequency waves to the matching box 17, the matching box 17 selectively generates the high frequency waves by on/off operation of a switch. That is, the matching box 17 includes the switch for controlling the generation of the high frequency waves such that the high frequency waves are generated using the electrical power supplied from the power supply 23 by turning on the switch. Therefore, the generation of the high frequency waves can be easily performed compared to the case where the generation of the high frequency waves is controlled by on/off operation of the power supply 23.

As shown in FIG. 5, the coil box 18 in which a heating coil 19 is mounted is connected to the bottom (e.g., a high frequency output terminal) of the matching box 17. The coil box 18 includes the heating unit 22 provided at the distal thereof to heat the inserted nut. The heating unit 22 is fixedly positioned in the heating coil 19 mounted in the coil box 18.

One side of the heating coil 19 is electrically connected to the high frequency output terminal of the matching box 17 and the other side thereof is wound on the heating unit 22 such that the heating unit 22 is inductively heated by the high frequency wave transmitted from the matching box 17.

That is, one side of the heating unit 22 is mounted in the coil box 18 and wound by the heating coil 19 and the other side thereof projects to the outside of the coil box 18 such that the heating unit 22 can be inserted into the inserted nut of the plastic part.

The heating unit 22 may be configured to have, for example, a cylindrical projection provided at the bottom thereof to heat an inserted nut. When the coil box 18 is moved down and fixed on the inserted nut, the projection of the heating unit 22 is received in the inserted nut, i.e., a nut inserted into the plastic part and, therefore, the workability is increased and rapid heating is achieved during induction heating.

Moreover, when the projection (which projects to the outside of the coil box 18) of the heating unit 22 is inserted into the inserted nut of the plastic part, it is in close contact with the inner circumference of the inserted nut, thus the heat transfer effect is increased. Here, the inserted nut is a metal having a high thermal conductivity and is heated by the heat transfer of the heating unit 22 to melt the plastic part. That is, when the inserted nut is heated, the plastic part having a relatively low melting temperature is melted, and thus the inserted nut can be separated and removed from the plastic part with ease.

Meanwhile, a cooler 27 for preventing the heating coil 19 from overheating is mounted in the lower portion of the work cabinet 1. The cooler 27 may be a water cooler, which is most widely used, and may include a pump (not shown) for circulation of coolant and a cooling fan (not shown) for cooling the coolant after cooling the heating coil 19.

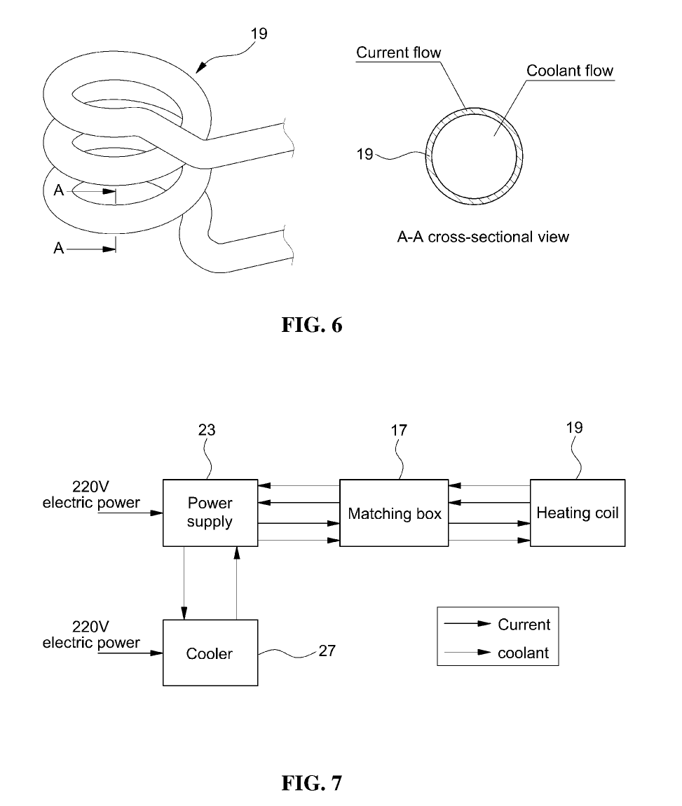

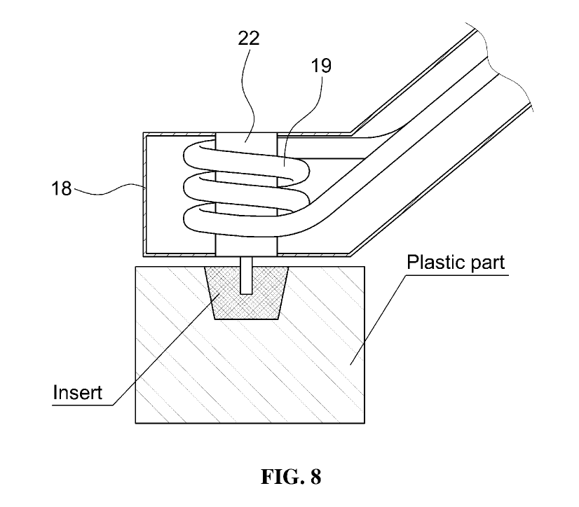

As shown in FIG. 7, the coolant of the cooler 27 flows to the heating coil 19 through the power supply 23 and the matching box 17 and cools the heating coil 19, thereby preventing the overheating of the power supply 23 and the match box 17 as well as the heating coil 19. In order to allow the coolant to flow through the heating coil 19, the heating coil 19 has a pipe structure with a tube-like cross section for simultaneous flow of the high frequency wave and the coolant.

In detail, as shown in FIG. 6, the heating coil 19 has a pipe structure such that the coolant supplied from the cooler 27 flows through the heating coil 19 and the high frequency waves transmitted from the matching box 17 flows along the outer surface of the heating coil 19. In turn, the heating coil 19 inductively heats the heating unit 22 by the high frequency waves flowing along the outer surface of the heating coil 19 and, at the same time, the cooler 27 allows the coolant flowing through the heating coil 19 to prevent the heating coil 19 from becoming overheated during heating of the heating unit 22. Here, the heating coil 19 is mounted in the coil box 18 and thus insulated from the outside, which improves the operation safety.

The power supply 23 generates electrical power of about 2.5 to 5.0 kW required for the generation of the high frequency waves by the matching box 17 and includes electrical wiring for supplying the generated current to the matching box 17. Although not shown in the figures, the electrical wiring together with a supply pipe for supplying the coolant of the cooler 27 and a collection pipe for collecting the coolant is connected to the heating coil 19 through the power supply 23 and the match box 17. Here, the electrical wiring may be connected to the outer surface of the heating coil 19, and the supply pipe and the collection pipe of the cooler 27 are connected to the inside of the heating coil 19.

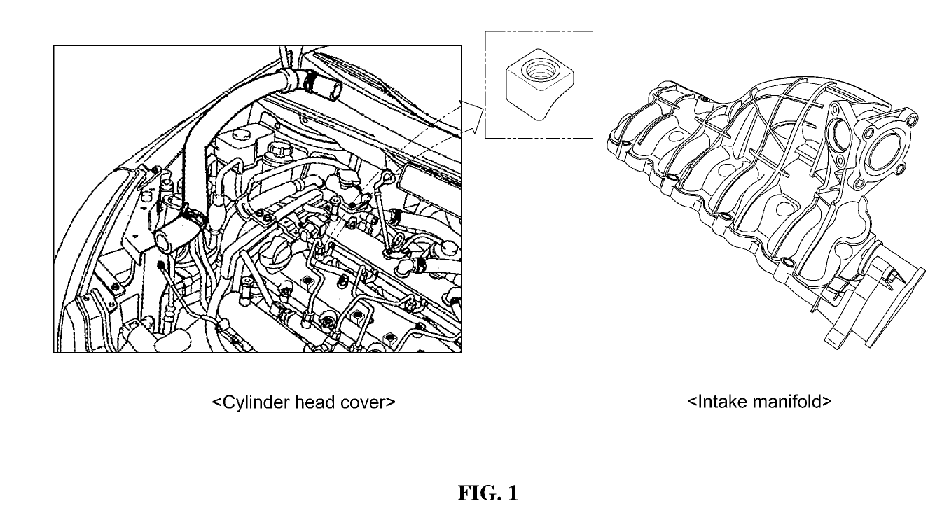

Meanwhile, as shown in FIG. 1, a control box 24 for controlling the operation of the power supply 23, the rotating table 2, the balancer 16, the cooler 27, a vent fan, which will be described later, other than the on/off operation of the matching box 17, is provided in the work cabinet 1. Moreover, a vent pipe 26 is provided at the top of the work cabinet 1 to discharge smoke generated when the plastic part is melted, and a vent fan is provided in the exhaust pipe for the discharge of smoke. Further, moving wheels 25 are mounted at the bottom of the work cabinet 1 to ensure the movability and workability of the work cabinet 1 and other components mounted thereon.

Next, a process of removing an inserted nut of a plastic part using the inserted nut removal system in accordance with the exemplary embodiment of the present invention will be described.

First, the power supply 23 is operated to supply the electrical power required for the generation of the high frequency waves to the matching box 17, and the cooler 27 is operated to prevent the heating coil 19 from overheating. The plastic part is placed on the support 3 of the rotating table 2, and the clamps 4 and 5 are operated to fix the plastic part. When the driven pulley 9 fixed on the rotating table 2 is rotated by the driving pulley 7, the movement converting unit 10 fixed at the bottom of the movement guide bar 11 performs rotational movement and moves linearly in the longitudinal direction of the driven pulley 9, thus allowing the movable clamp 5 to move toward the fixed clamp 4.

Then, the plastic part is brought into contact with the fixed clamp 4 and fixed between the clamps 4 and 5. As such, when the plastic part is fixed on the support 3 of the rotating table 2, the matching box 17 connected to the balancer 16 is moved down onto the inserted nut to be removed.

At this time, as shown in FIG. 8, the position of the heating unit 22 is accurately adjusted by holding a handle of the match box 17 such that the heating unit 22 of the coil box 18 is inserted and fixed to the inside of the inserted nut. Then, the switch of the match box 17 is pressed to generate high frequency waves for about 3 to 5 seconds, thereby inductively heating the inserted nut. In turn, the inserted nut (made of metal) is heated to melt the plastic surrounding the inserted nut. That is, the peripheral plastic part (i.e., a portion being in close contact with the inserted nut) is melted by the heated inserted nut having a high thermal conductivity and, as a result, the inserted nut can be separated from the plastic part.

As such, when the inserted nut is heated and the periphery of the inserted nut is melted, the balancer 16 is operated such that the matching box 17 is moved up, and the inserted nut is removed using a tool such as snap ring pliers or screwdriver.

After the process of removing the inserted nut of the plastic part is completed by repeating these processes, the movable clamp 5 is returned to its original position, and the plastic part is removed from the support 3. As such, the inserted nut removal system using the high frequency waves according to the present invention can rapidly and conveniently remove metal inserted into a plastic part by using high frequency waves, and thus the recyclability of the engineered plastic parts, which were previously difficult to recycle due to the metal insert, can be improved.

For example, the large parts such as cylinder head covers, intake manifolds, etc. have been replaced with engineered plastic parts for the purpose of reduction of the engine weight, and in this state, the corresponding plastic parts can be recycled by rapidly removing the inserts using the inserted nut/metal removal system of the present invention.

In particular, the price of polyamide (PA) materials is about two times higher than that of polypropylene materials, which are widely used as the plastic materials, and therefore it is expected that the recycling of the PA materials can have significant economic effects on a companies costs.

As described above, with the use of the inserted nut removal system using the high to frequency wave according to the present invention, it is possible to rapidly and conveniently remove the metal insert from the engineering plastic part, which is difficult to recycle due to the metal insert, and thus the recyclability of the plastic parts can be improved.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An inserted nut removal system using a high frequency wave, the system comprising:
a rotating table on which a plastic part with an inserted nut therein is placed and fixed;
a matching box configured to be moved up and down on the inserted nut of the plastic part by a balancer provided at a top of the rotating table wherein the matching box is configured to generate and transmit high frequency waves;
a coil box including a heating coil mounted therein, the coil box configured to inductively heat a heating unit provided at a distal end of the coil box by the high frequency waves transmitted from the matching box; and
a cooler configured to prevent the heating coil from overheating,
wherein the inserted nut is heated by heat transfer from the heating unit to melt a periphery of the plastic part surrounding a periphery of the inserted nut.

2. The system of claim 1, wherein the rotating table comprises a fixed clamp and a movable clamp, which are configured to clamp the plastic part in such a manner that the movable clamp, which is configured to move linearly toward the fixed clamp, brings the plastic part into close contact with the fixed clamp to be fixed between the clamps.

3. The system of claim 1, wherein the rotating table is rotatably mounted.

4. The system of claim 2, wherein the movable clamp comprises a movement guide bar provided at the bottom of the movable clamp and configured to guide the linear movement of the movable clamp, the movement guide bar being provided to move linearly along guide rails.

5. The system of claim 1, wherein the heating coil has a pipe structure with a tube-like cross section such that coolant flows through the inside of the heating coil and the high frequency waves flow along the outer surface of the heating coil.

6. The system of claim 1, wherein the rotating table is provided on a work cabinet, and the work cabinet includes moving wheels mounted at the bottom of the work cabinet to ensure the movability of the work cabinet.

7. An inserted metal removal system using high frequency waves, the system comprising:
a rotating table on which a plastic part with metal therein is placed and fixed;
a matching box being moved up and down on the inserted metal of the plastic part by a balancer provided above the rotating table wherein the matching box is further configured to generate and transmit high frequency waves;
a coil box including a heating coil mounted therein to heat a heating unit provided at a distal end of the coil box by the high frequency waves transmitted from the matching box; and
a cooler for preventing the heating coil from overheating,
wherein the inserted metal is heated by the heat transfer of the heating unit to melt a periphery of the plastic part surrounding a periphery of the inserted metal.

8. The system of claim 7 wherein the metal inserted in the plastic part is a metal nut.

9. The system of claim 7, wherein the rotating table comprises a fixed clamp and a movable clamp, which are configured to clamp the plastic part in such a manner that the movable clamp, which is configured to move linearly toward the fixed clamp, brings the plastic part into close contact with the fixed clamp to be fixed between the clamps.

10. The system of claim 9, wherein the rotating table is rotatably mounted.

11. The system of claim 10, wherein the movable clamp comprises a movement guide bar provided at the bottom of the movable clamp and configured to guide the linear movement of the movable clamp, the movement guide bar being provided to move linearly along guide rails.

12. The system of claim 9, wherein the heating coil has a pipe structure with a tube-like cross section such that coolant flows through the inside of the heating coil and the high frequency waves flow along the outer surface of the heating coil.

13. The system of claim 9, wherein the rotating table is provided on a work cabinet, and the work cabinet includes moving wheels mounted at the bottom of the work cabinet to ensure the movability of the work cabinet.

14. A method comprising:
placing and fixing a plastic part with metal therein on a rotating table on which;
moving a matching box up and down on the inserted metal by a balancer provided above the rotating table
generating and transmitting high frequency waves by the matching box;
heating, by a coil box including a heating coil mounted therein, a heating unit provided at a distal end of the coil box by the high frequency waves transmitted by the matching box; and
cooling, by a cooler, the heating coil while at the same time melting a periphery of the plastic part surrounding a periphery of the inserted metal by the heat transfer of the heating unit.
